(19) United States
(12) Patent Application Publication
(10) Pub. No.: US 2022/0067270 A1
(43) Pub. Date: Mar. 3, 2022

(54) FORM FIELD POPULATION WITH TEXT RELATED TO DIGITAL-ASSISTANT QUERY

(71) Applicant: MOTOROLA SOLUTIONS, INC., Chicago, IL (US)

(72) Inventors: CHUN MENG TAN, BAYAN LEPAS (MY); CHOON KEAT LIM, PAYA TERUBONG (MY); CARMEN JIA YI SIAU, KOTA KINABALU (MY); CHUNG YONG CHONG, BAYAN LEPAS (MY)

(21) Appl. No.: 17/002,815

(22) Filed: Aug. 26, 2020

(51) Int. Cl. G06F 40/174; G06F 40/279; G06F 40/274; G06F 16/338; G06Q 50/26

(52) U.S. Cl. CPC G06F 40/174; G06F 40/279; G06Q 50/26; G06F 16/338; G06F 40/274

(57) ABSTRACT

A method and apparatus for populating a form with text relevant to past digital-assistant queries is provided herein. During operation, a device will store text related to all digital-assistant queries during a particular incident, and text related to responses to the queries that are initiated during the particular incident. At a later time, when a form is being filled out by an officer, the form will be pre-populated with the text related to the digital-assistant queries and responses. In one embodiment the text related to the digital-assistant queries and responses comprises text of the actual query and text of the actual response.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “digital assistants”) that may provide the user thereof with valuable information in an automated (e.g., without further user input) or semi-automated (e.g., with some further user input) fashion. The valuable information provided to the user may be based on explicit queries for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, answering queries, searching databases, and providing many other types of information in a reactive or proactive manner.

During many incidents, a first responder will query a digital assistant with needed information about the incident. For example, during an investigation, a digital assistant may be queried about the owner of a particular automobile, a license-plate lookup, addresses of suspects, . . . , etc. These queries may be numerous for incidents that take a long period of time to dispose of.

As part of a first responder's duties, various reports need to be filled out after every incident. Due to time constraints, many forms cannot be filled in their entirety while at a particular incident, leaving the remainder of the form to be filled at a later time. It would be beneficial for first responders if various fields of a form could be pre-populated with text, or text suggestions in a manner that would aid in filling out a form in the most efficient manner. It would also be beneficial if the user's queries to their digital assistant can be utilized to aid in filling out the various reports.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates the automatic population of a form.

FIG. 2 illustrates suggested text that can be used to populate a form.

FIG. 3 is a general operating environment for use of the present invention.

FIG. 4 is a block diagram of a device used to store queries in database.

FIG. 5 is a block diagram of a device uses to automatically populate forms with text.

FIG. 6 is a flow chart showing the operation of the device of FIG. 5.

FIG. 7 is a flow chart showing the operation of the device of FIG. 5.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for populating a form with text relevant to past digital-assistant queries and responses are provided herein. During operation, a device will store text related to all digital-assistant queries during a particular incident, and text related to responses to the queries that are initiated during the particular incident. At a later time, when a form is being filled out by an officer, the form will be pre-populated with the text related to the digital-assistant queries and responses. In one embodiment the text related to the digital-assistant queries and responses comprises text of the actual query and text of the actual response.

Expanding on the above, a current incident type may be determined, and a particular form presented to an officer may be chosen based on a particular incident attended to by an officer. Once the particular form is chosen, fields of the form will be pre-populated with text related to any digital-assistant queries and responses made during the officer's handling of the particular incident.

Consider the following example: After a busy day-long operation, an officer needs to write a report about the operation. The officer may have forgotten certain details about the day-long operation. In order to aid in the writing of the report, the report will be pre-populated with text related to what questions the officer has asked his digital assistant during the time period that the operation was taking place. Text related to the answers provided by the digital assistant may also be pre-populated within the report.

The term “report” and “form” are intended to be interchangeable, with the report preferably comprising a completed, or semi-completed form. More particularly, a report comprises a written account of a particular incident that was investigated by an officer. The report preferably comprises at least one completed, or semi-completed form, with the form comprising an electronic document with blank spaces for information to be inserted.

It should be noted that in an embodiment of the present invention, a computer-aided dispatch (CAD) incident identifier (ID) is utilized to identify a current task or incident assigned to an officer. An incident identification (sometimes referred to as an incident scene identifier, or a CAD identifier) is generated for incidents where an officer is dispatched. This ID could be something as simple as a number, or something as complicated as an identification that is a function of populated fields, one of which may comprise an incident type. Another field of the CAD_ID may comprise a location. It is envisioned that a field of the form/report will comprise a CAD ID.

It should be noted that all of an officer's queries may not be relevant to the current incident. For example, an officer might ask their digital assistant what the weather is going to be like tomorrow. Therefore, a technique to determine relevance of queries and their responses is sometimes needed to prevent text related to non-relevant queries and responses from being pre-populated into any form about an incident. In order to determine a relevance of a query and response, certain keywords within the query or answer may be used to determine if any query or answer is relevant to the incident. For example, questions or answers having keywords related to suspects, vehicles, weapons, criminal histories, addresses, . . . , etc. will be deemed as relevant to a particular incident, whereas all other queries may be deemed not relevant to the particular incident.

In another embodiment of the present invention, relevance may be determined based on past similar queries for similar incidents. More particularly, if a current query is similar to past queries that have been presented for past similar incidents, the current query and its response are deemed relevant to the particular incident.

In another embodiment of the present invention, relevance may be determined based on past similar queries for similar incidents at a particular point in the incident progression. More particularly, if a current query is similar to past queries that have been presented for past similar incidents at the point of incident progression (e.g. road chase started, suspect arrested and etc.), the current query and its response are deemed relevant to the particular incident state.

In another embodiment of the present invention, relevance may be determined based on past similar queries for similar job scope. More particularly, if a current query is similar to past queries that have been presented for past similar job duty scope or assignment (e.g. police taking care of the traffic, police interviewing witness, paramedic taking care the casualty and etc.), the current query and it's response are deemed relevant to the particular incident state.

In one embodiment of the present invention, relevant queries asked during the handling of an incident (e.g., during the time period an officer is assigned to the incident) will be pre-populated within the form related to the particular incident. Pre-population of text takes place when the form has the text within a field without any user input to that field.

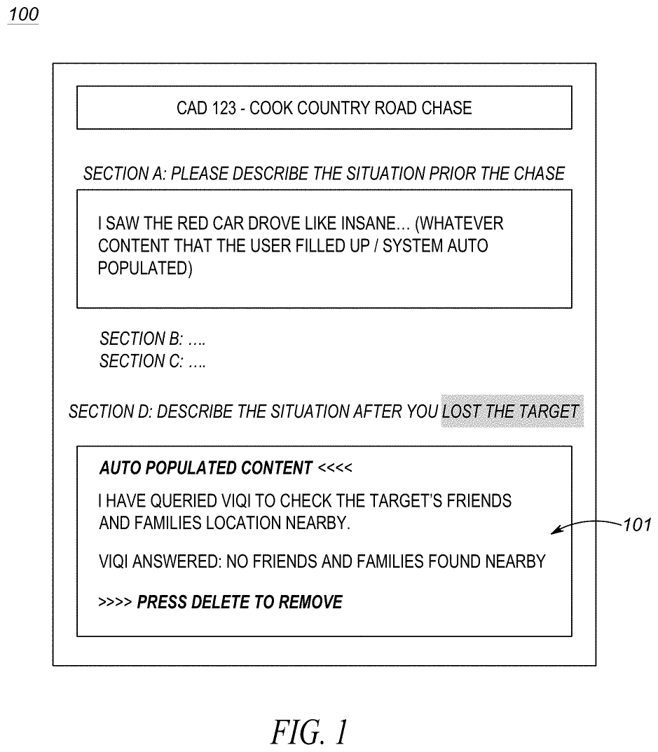

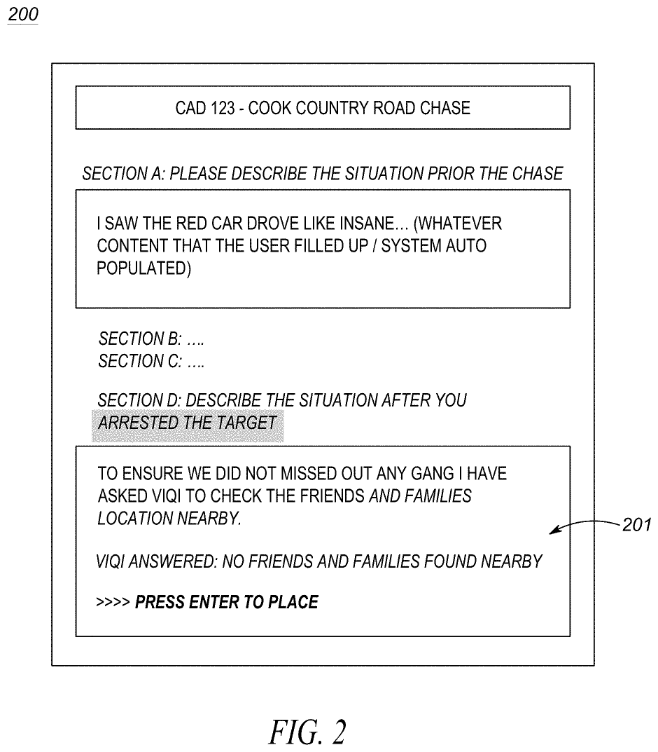

However, non-relevant queries will not be pre-populated within the form. The non-relevant queries may be “suggested” in a form via an auto-complete suggestion when it is determined that text related to the non-relevant query is being input by the officer. When using auto-complete, as a user is typing a current word or phrase, a suggested word or phrase will be provided to the user that attempts to predict what the user is typing. The above is illustrated in FIG. 1 and FIG. 2.

As shown in FIG. 1, form 100 has been automatically populated (i.e., pre-populated) with text 101 within a form related to a road chase. The text is related to a query asked by an officer and consists of the query and the response from the digital assistant. Because the query and response was deemed relevant, the text was pre-populated into form 100. This is not the case in FIG. 2. As shown in FIG. 2, form 200 has not been automatically pre-populated with text 201, but the text has been suggested only after the officer began to type text that is potentially related to the query and the response. The officer can choose to accept the text input or not. Thus, in FIG. 2, text related to the query in response is only suggested after the officer begins typing text that is related to a past query.

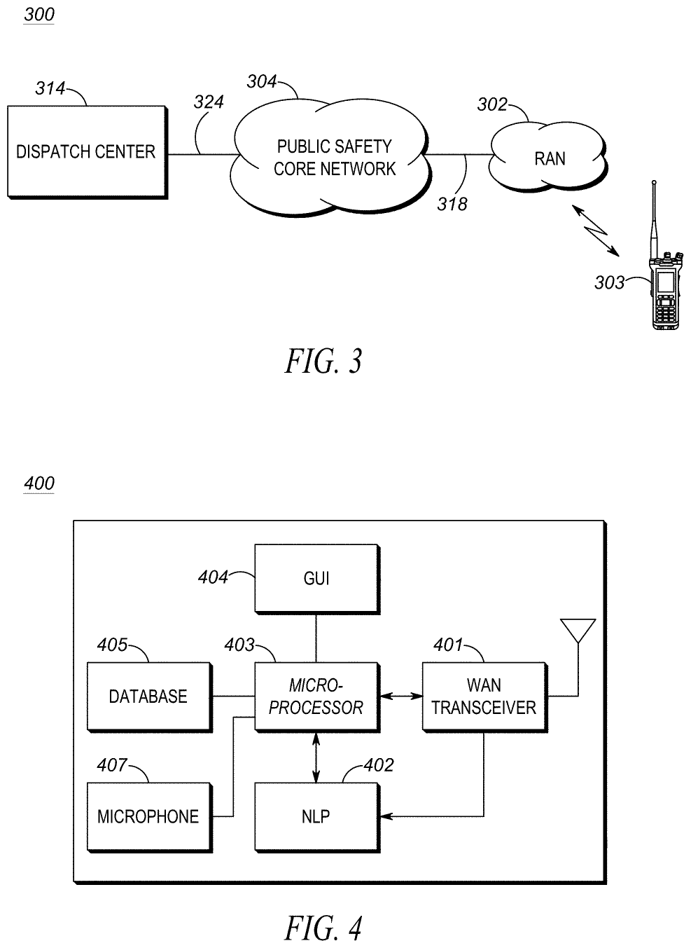

FIG. 3 depicts an example communication system 300 that incorporates the above-described technique for populating a form. System 300 includes one or more radio access networks (RANs) 302, a public-safety core network 304, radio 303, dispatch center 314, and communication links 318 and 324.

RAN 302 includes typical RAN elements such as base stations, base station controllers (BSCs), routers, switches, and the like, arranged, connected, and programmed to provide wireless service to user equipment (e.g., radio 303, and the like) in a manner known to those of skill in the relevant art. RAN 302 may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RAN 302 may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, RAN 302 may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

Public-safety core network 304 may include one or more packet-switched networks and/or one or more circuit-switched networks, and in general provides one or more public-safety agencies with any necessary computing and communication needs, transmitting any necessary public-safety-related data and communications.

Radio 303 may be any suitable computing and communication devices configured to engage in wireless communication with the RAN 302 over the air interface as is known to those in the relevant art.

Dispatch center 314 comprises, or is part of a computer-aided-dispatch center, manned by an operator providing necessary dispatch operations. For example, dispatch center 314 typically comprises a graphical user interface that provides the dispatch operator necessary information about public-safety officers.

It should be noted that dispatch center 314 and/or radio 303 comprises circuitry configured to function as a digital assistant. Such circuitry is configured to receive a query from an officer and provide a response to the query. The digital assistant circuitry may be wholly located in either dispatch center 314, radio 303, may be distributed among network equipment shown in FIG. 3, or may exist in any other piece of equipment not shown in FIG. 3.

With the above in mind, dispatch center 314 and radio 303 may be configured with a natural language processing (NLP) engine (not shown in FIG. 3) configured to determine the intent and/or content of the any over-the-air voice transmissions received by users. The NLP engine may also analyze oral queries and/or statements received by any user and provide responses to the oral queries and/or take other actions in response to the oral statements.

FIG. 4 sets forth a schematic diagram that illustrates a device 400 to aid in populating a form with text as described above (i.e., pre-populated and/or auto-complete suggestion). In an embodiment, the device is embodied within dispatch center 314 or radio 303, however in alternate embodiments the device may be embodied within the public-safety core network 304, or more computing devices in a cloud compute cluster (not shown), or some other communication device not illustrated in FIG. 3, and/or may be a distributed communication device across two or more entities.

FIG. 4 shows those components (not all necessary) for device 400 to create data used populate forms with text based on queries made to the digital assistant. As shown, device 400 may include a wide-area-network (WAN) transceiver 401 (e.g., a transceiver that utilizes a public-safety communication-system protocol), Natural Language Processor (NLP) 402, logic circuitry 403 (which may serve as a digital assistant), database 405, and graphical-user interface (GUI) 404. In other implementations, device 400 may include more, fewer, or different components. Regardless, all components are connected via common data busses as known in the art.

WAN transceiver 401 may comprise well known long-range transceivers that utilize any number of network system protocols. (As one of ordinary skill in the art will recognize, a transceiver comprises both a transmitter and a receiver for transmitting and receiving data). For example, WAN transceiver 401 may be configured to utilize a next-generation cellular communications protocol operated by a cellular service provider, or any public-safety protocol such as an APCO 25 network or the FirstNet broadband network. It should be noted that WAN transceiver 401 is shown as part of device 400, however, WAN transceiver 401 may be located in RAN 202 (e.g., a base station of RAN 202), with a direct link to device 400. During operation, when device 400 is located within dispatch center 314, queries may be received over WAN transceiver 401 from radio 303. However, if device 400 is located within radio 303, a query may be received from microphone 407 and passed (via WAN 401) to dispatch center 314. A response to the query may be received from dispatch center 314 as part of digital assistant operation.

NLP 402/logic circuitry 403 may be a well known circuitry to analyze, understand, and derive meaning from human language in a smart and useful way. By utilizing NLP, automatic summarization, translation, named entity recognition, relationship extraction, sentiment analysis, speech recognition, and topic segmentation can take place and thus determine that a user asked a particular query that may be acted on by device 400.

Logic circuitry 403 comprises a digital signal processor (DSP), general purpose microprocessor, a programmable logic device, or application specific integrated circuit (ASIC) and is configured to also compile a database of queries asked, and responses given, during a particular incident, along with whether or not the queries were relevant to the particular incident.

Logic circuitry 403 along with NLP 402 is also configured to serve as a digital assistant/digital assistant in order to provide an answer to any query. For example, logic circuitry may provide the user thereof with valuable information in an automated (e.g., without further user input) or semi-automated (e.g., with some further user input) fashion. The valuable information provided to the user may be based on explicit requests for such information posed by the user via a query (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

Database 405 is provided. Database 405 comprises standard memory (such as RAM, ROM, . . . , etc) and serves to store an identification of an incident (e.g., CAD ID), along with queries and answers that were asked by an officer during the incident. This is illustrated in Table 1.

TABLE 1
Queries and their associated responses and incident identification

| | | | Relevant to |
|---|---|---|---|
| Incident ID | Query | Response | Incident? |
| 10023405 | License plate lookup | The license plate is | Yes |
| | for SU2608 | registered to a Mr. | |
| | | Peter Smith . . . | |
| 10023405 | What is the high | 78 degrees | No |
| | temperature for | | |
| | today? | | |
| 100238587 | Lookup Drivers | The drivers license | Yes |
| | License | comes back valid and | |
| | H20050165848 | registered to a Mr. . . . | |
| . . . | . . . | . . . | . . . |

Finally, GUI 404 comprises a man/machine interface for receiving an input from a user and displaying information. For example, GUI 404 may provide a way of conveying (e.g., displaying) information received from processor 403. Part of this information may comprise a text query and a response to the query. In order to provide the above features (and additional features), GUI 404 may comprise any combination of a touch screen, a computer screen, a keyboard, or any other interface needed to receive a user input and provide information to the user.

The components shown in FIG. 4 are preferably configured to store queries and responses in database 405 that are received during a time period a user is assigned to a particular incident. During operation, microphone 407 or WAN transceiver 401 will receive a query that was spoken or typed by a user. Logic circuitry 403/NLP circuitry 402 will determine the content of the query and perform the appropriate database search. As is known in the art, the database search may comprise a search of an internal database 405, or an external database (not shown in FIG. 4) via a network connection (not shown in FIG. 4). After the appropriate database search, a response to the query is determined and provided to the user via GUI 404. Alternatively, the response may be transmitted to a user via WAN 401.

As discussed above with regards to Table 1, text related to the query and text related to the response will be stored in database 405 with the associated incident identification and potentially a relevance indication.

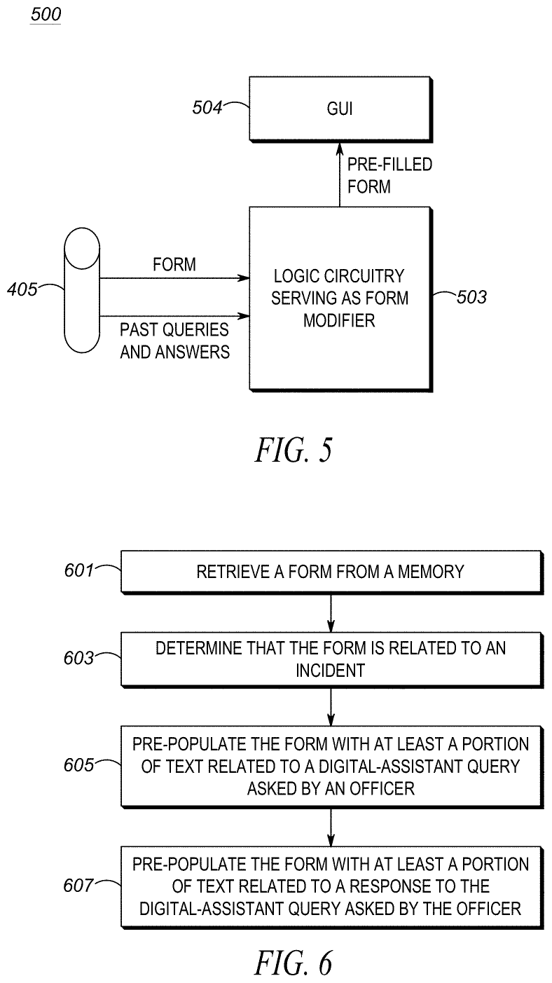

FIG. 5 illustrates apparatus 500 utilized to populate a report as described above. Apparatus 500 comprises GUI 504 that includes a man/machine interface for receiving an input from a user and displaying information. For example, GUI 504 may provide a way of conveying (e.g., displaying) a form that has been pre-populated with data that was received from processor 503. GUI 504 also allows a user to edit the form. In order to provide the above features (and additional features), GUI 504 may comprise any combination of a touch screen, a computer screen, a keyboard, or any other interface needed to receive a user input and provide information to the user.

Logic circuitry 503 comprises a digital signal processor (DSP), general purpose microprocessor, a programmable logic device, or application specific integrated circuit (ASIC) and is configured to access database 405 and pre-populate forms with user queries and responses/answers as described above.

During operation of apparatus 500, an officer will utilize GUI 404 to retrieve an electronic form stored in database 405. When retrieving the form, the officer will provide information on what incident the form is related to. For example, the officer may provide a CAD ID to logic circuitry 503 prior to, or after retrieving the form. When an officer retrieves the electronic form stored in database 405, logic circuitry 503 will access database 405 and also determine any queries/responses made to a digital assistant during the handling of the incident associated with the CAD ID. The queries/responses may also be determined as relevant or non-relevant to the incident associated with the CAD ID.

Those queries and responses associated with the CAD ID may have text associated with the queries and responses pre-populated by logic circuitry 503 into the retrieved form prior to being presented to the officer on GUI 504. The queries and responses may be pre-populated into a predetermined part or field of the form.

As discussed, in an alternate embodiment only those queries and responses determined to be relevant to the incident may be pre-populated. When this is the case, as the officer inputs text into the form, logic circuitry 503 will monitor the text to see if the text is related to any non-relevant query and response associated with the incident associated with the CAD ID. If the officer inputs text into the form that appears to be related to any non-relevant query/response associated with the incident (for example, a predetermined number of characters input by the officer matches characters in the non-relevant query), then logic circuitry will suggest an input text string to the user (as shown in FIG. 2). Logic circuitry 503 may determine that text being input is relevant to a query when the text being input matches a portion of the query (e.g., 5 words being input match 5 words of the query).

As discussed above, there are two techniques for populating a form. In particular, a first technique pre-populates the form with query text. This technique may be used while filling out a form about an incident for all digital assistant queries made while assigned to an incident. Alternatively, this technique may only be used for those digital-assistant queries deemed relevant to the incident.

A second technique suggests query-related text to auto-complete a sentence or paragraph. When utilizing auto-complete, text is suggested as part of an auto-complete procedure. As known in the art, auto-complete, or word completion, is a feature in which a device predicts the rest of a sentence or paragraph a user is typing. In graphical user interfaces, users can typically press the tab key to accept a suggestion.

The second technique may be used while filling out a form about an incident for all digital assistant queries made while assigned to an incident. Alternatively, this technique may only be used for those digital-assistant queries deemed not-relevant to the incident.

A combination of pre-population and auto-complete may be used. In this scenario, a form will be pre-populated with query-related text that is determined to be relevant to a particular incident, but at a later time, text may be suggested as part of an auto-complete feature for query-related text that is determined to not be relevant to a particular incident.

With the above in mind, when pre-populating forms, the apparatus of FIG. 5 comprises logic circuitry 503 that is configured to determine that the form is related to an incident, pre-populate the form with at least a portion of text related to a digital-assistant query asked by an officer, and pre-populate the form with at least a portion of text related to a response to the digital-assistant query asked by the officer. As discussed, the digital-assistant query was asked by the officer during a time period the incident was being handled by the officer, and the response to the digital-assistant query was provided by a digital assistant during the time period the incident was being handled by the officer.

When providing an auto-complete option for a user, the apparatus of FIG. 5 comprises a graphical-user interface (GUI) 504 configured to receive text input from an officer to be placed into the form. Logic circuitry is provided, and configured to retrieve a form from a memory 405, determine that the form is related to an incident, access database 405 to determine that the text input from the officer matches a portion of text of a digital-assistant query asked by the officer or that the text input from the officer matches a portion of text of a digital-assistant response to the digital-assistant query asked by the officer, and provide a suggestion via the GUI to the officer of potential text to be input into the form as part of an auto-complete suggestion, wherein the potential text comprises at least a portion of the digital-assistant query or at least a portion of the digital-assistant response. As discussed, the digital-assistant query was asked by the officer during a time period the incident was being handled by the officer, and the response to the digital-assistant query was provided by a digital assistant during the time period the incident was being handled by the officer.

FIG. 6 is a flow chart showing the operation of the device of FIG. 5. More particularly, the logic flow of FIG. 6 shows those steps (not all necessary) to pre-populate a form with text related to a query that was asked during the handling of an incident. The logic flow begins at step 601 where logic circuitry 503 retrieves a form from memory 405.

At step 603, logic circuitry provides the form to GUI 504 and determines that the form is related to an incident. This determination may be made by receiving an incident identification from GUI 504 as part of a user filling in fields of the form.

At step 605, logic circuitry 503 uses the incident identification to pre-populating the form with at least a portion of text related to a digital-assistant query asked by an officer. As discussed above, during this process, logic circuitry 503 accesses memory 405 and determines queries that were made by the officer during the officer's handling of the incident. Text related to these queries (or alternatively, text related to only relevant queries) may then be pre-populated into the form.

At step 607, logic circuitry 503 uses the incident identification to pre-populating the form with at least a portion of text related to a response to the digital-assistant query asked by the officer. As discussed above, during this process, logic circuitry 503 accesses memory 405 and determines digital assistant responses made in to officer queries during the officer's handling of the incident. Text related to these responses (or alternatively, text related to only relevant responses) may then be pre-populated into the form.

As discussed above, the digital-assistant query was asked by the officer during a time period the incident was being handled by the officer, and the response to the digital-assistant query was provided by a digital assistant during the time period the incident was being handled by the officer.

Additionally, the incident preferably comprises a public-safety incident in which the officer was assigned.

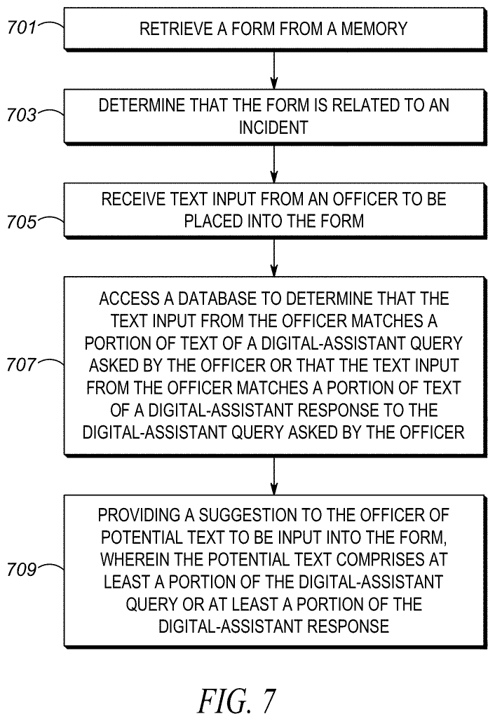

FIG. 7 is a flow chart showing the operation of the device of FIG. 5. More particularly, the logic flow of FIG. 7 shows those steps (not all necessary) to auto-complete a form with text related to a query that was asked during the handling of an incident. As discussed above, auto-complete is different than pre-populate in that pre-populated forms already have text input into relevant fields, while, auto-complete will only suggest text to a user, and populates the form with the suggested text only after being accepted by the user. The logic flow begins at step 701 where logic circuitry 503 retrieves a form from memory 405.

At step 703, logic circuitry provides the form to GUI 504 and determines that the form is related to an incident. This determination may be made by receiving an incident identification from GUI 504 as part of a user filling in fields of the form.

At step 705, GUI 504 receives text input from an officer to be placed into the form, and provides the text to logic circuitry 503. At step 707, logic circuitry 503 then accesses database 405 to determine that the text input from the officer (received from GUI 504) matches a portion of text of a digital-assistant query asked by the officer or that the text input from the officer matches a portion of text of a digital-assistant response to the digital-assistant query asked by the officer.

Finally, at step 709, logic circuitry 503 provides a suggestion to the officer of potential text to be input into the form as part of an auto-complete procedure. Particularly, the potential text comprises at least a portion of the digital-assistant query or at least a portion of the digital-assistant response.

As discussed above, the digital-assistant query was asked by the officer during a time period the incident was being handled by the officer, and the response to the digital-assistant query was provided by a digital assistant during the time period the incident was being handled by the officer.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for populating a form with text related to a digital-assistant query, the method comprising the steps of:
retrieving a form from a memory;
determining that the form is related to an incident;
determining text related to a digital-assistant answer;
determining second text related to a second digital-assistant answer;
determining that the text related to the digital-assistant answer is relevant to an incident by determining that certain keywords within the answer are relevant to the incident, a query is similar to past queries that have been presented for past similar incidents, or the query is similar to past queries that have been presented for past similar jobs;
determining that the second text related to the second digital-assistant answer is not relevant to the incident;
pre-populating the form with at least a portion of text related to a digital-assistant answer asked by an officer while not pre-populating the form with any of the second text related to the second digital-assistant answer; and
wherein the digital-assistant answer was in response to a question asked by the officer during a time period the incident was being handled by the officer.

2. The method of claim 1 wherein the incident comprises a public-safety incident in which the officer was assigned.

3. (canceled)

4. (canceled)

5. (canceled)

6. An apparatus for populating a form with text related to a digital-assistant answer, the apparatus comprising:
logic circuitry configured to:
determine that the form is related to an incident;
determine text related to a digital-assistant answer;
determine second text related to a second digital-assistant answer;
determine that the text related to the digital-assistant answer is relevant to an incident by determining that certain keywords within the answer are relevant to the incident, a query is similar to past queries that have been presented for past similar incidents, or the query is similar to past queries that have been presented for past similar jobs;
determine that the second text related to the second digital-assistant answer is not relevant to the incident;
pre-populate the form with at least a portion of text related to a digital-assistant answer asked by an officer; and
wherein the digital-assistant answer was in response to a question asked by the officer during a time period the incident was being handled by the officer.

7. The apparatus of claim 6 wherein the incident comprises a public-safety incident in which the officer was assigned.

8. (canceled)

9. (canceled)

10. (canceled)
